(19) United States
(12) Patent Application Publication
(10) Pub. No.: US 2011/0051934 A1
(43) Pub. Date: Mar. 3, 2011

(54) DATA RECEIVING DEVICE, DATA RECEIVING METHOD AND PROGRAM

(75) Inventor: Motoshige IKEDA, Kanagawa (JP)

(73) Assignee: NEC ELECTRONICS CORPORATION, Kawasaki (JP)

(21) Appl. No.: 12/823,768

(22) Filed: Jun. 25, 2010

(30) Foreign Application Priority Data
Aug. 25, 2009 (JP) 2009-194073

(51) Int. Cl. H04K 1/00

(52) U.S. Cl. 380/287

(57) ABSTRACT

A data receiving device includes an elastic buffer which receives data as receiving data and adjusts timing with a sender, the data being scrambled and sent from the sender, an interpolation circuit which performs predetermined interpolation processing on the data subjected to timing adjustment by the elastic buffer to output the data, and a descramble circuit which descrambles the data output from the interpolation circuit. The receiving data includes data set for adjusting timing. The data set is for adjusting timing with the sender. The interpolation circuit replaces existing data with data for adjusting timing and outputs the data for adjusting timing as required after first receiving normal data for adjusting timing so that a desired number of data for adjusting timing is included in the data set for adjusting timing.

### INCORPORATION BY REFERENCE

This application is based upon and claims the benefit of priority from Japanese patent application No. 2009-194073, filed on Aug. 25, 2009, the disclosure of which is incorporated herein in its entirety by reference.

### BACKGROUND

1. Field of the Invention

The present invention relates to a data receiving device, a data receiving method and a program product to perform high speed serial transfer, and particularly to a data receiving device, a data receiving method and a program to stabilize data receiving.

2. Description of Related Art

In high speed serial transfer, clock is superimposed on data, and sending data is subjected to a scramble processing so as to avoid periodicity (continuous data of the same pattern) of dada in a data receiving device in order to isolate the clock from the data. Therefore the received data is subjected to a descramble processing.

As a related data receiving device, Japanese Unexamined Patent Application Publication No. 2005-268910 (Tozaki) discloses a data receiving device that allows an initialization of a descramble circuit even if a symbol for initializing such as COM symbol or data for adjusting timing such as SKP symbol are partially damaged by noise of a transmission channel. Note that, hereinafter PCI Express bus method will be described as an example.

FIG. 10 is a block diagram showing a data transfer device of PCI Express bus method when the technique of Tozaki is not employed.

Sending data is scrambled by a scramble circuit 101. Next, eight-bit data is encoded into ten-bit data by an 8 B/10 B encode circuit 102 so as not to continue “0” or “1” for a predetermined number of times. Then parallel data is converted into serial data by a P/S conversion circuit 103 and the serial data is sent to a sending channel (lane) 104 of a differential type.

The data sent from a receiving channel (lane) 105 of a differential type is converted to parallel data from serial data by an S/P conversion circuit 106. Then a deviation of a clock frequency (gap) between a sender side and a receiver side is corrected in an elastic buffer 107. After that, ten-bit data is decoded into eight-bit data in an 8 B/10 B decode circuit 108 and the eight-bit data is descrambled in a descramble circuit 110.

In this PCI Express bus method, scramble processing of the scramble circuit 101 and descramble processing of the descramble circuit 110 are each performed by a circuit using a linear feedback shift resistor (LFSR).

The scramble circuit 101 and the descramble circuit 110 operate according to the following rules such as; the shift resister is initialized into an initial value (FFFFh) with a COM symbol and LFSR shifts with symbols except a SKP symbol (LFSR does not shift with a SKP symbol); scramble and descramble processing are performed with all D code except a training sequence and a compliance pattern; and scramble and descramble processing are not performed with all K code.

Here, COM symbol is data which initializes the scramble circuit 101 and the descramble circuit 110, and indicates a symbol for initializing. SKP symbol is data for adjusting timing which does not shift LSFRs of the scramble circuit 101 and the descramble circuit 110 and corrects a deviation of a clock frequency (gap) between a sender side and a receiver side. The K code includes 12 kinds of specific data other than normal data, and includes the COM symbol and SKP symbol. On the other hand, the D code indicates data symbols other than data for controlling such as K code.

In PCI Express bus method, at Idle timing of data transfer (D 0.0, that is when 00h of D code is sent), data set for adjusting timing (SKP ordered set) are inserted at regular intervals (for every 1080-1156 symbols). This SKP ordered set is composed of one COM symbol and the following three SKP symbols. In the elastic buffer circuit 107, the deviation of the clock frequency (gap) is corrected by changing the number of SKP symbols of the SKP ordered set.

That is, when the frequency of receiver is larger than that of the sender, a physical layer of the receiver adds SKP symbol which is included in the SKP ordered set to the SKP ordered set, and sends it to a link layer. On the other hand, when the frequency of the sender is larger than that of the receiver, the physical layer of the receiver deletes the SKP symbol included in the SKP ordered set, and sends it to the link layer.

As noted above, the LFSRs of the scramble circuit 101 and the descramble circuit 110 are initialized by the COM symbol. As the SKP symbol may be deleted or added in the receiver side, the LFSRs of the scramble circuit 101 and the descramble circuit 110 do not operate. That is, the LFSRs of the scramble circuit 101 and descramble circuit 110 operate with symbols other than the SKP symbol.

However, in the data transfer device as described above, when the received data is damaged and the COM symbol cannot be received, the LFSR in the descramble circuit 110 cannot be initialized, and then the value of the LFSR does not correspond to the value of the LFSR of the scramble circuit 101 of the sender side. Further, when the SKP symbol has been damaged and changed to a different value, the LFSR of the descramble circuit 110 would shift, although the LFSR of the descramble circuit 110 should not shift in a normal situation In this case as well, the value of the sender and that of the receiver are different, and then correct data cannot be received.

Therefore, even if a part of the symbol for initializing such as the COM symbol or the data for adjusting timing such as the SKP symbol is damaged, the data receiving device described in Tozaki allows initialization of the descramble circuit.

FIG. 11 is a view showing the data receiving device of Tozaki. As shown in FIG. 11, the data receiving device described in Tozaki includes the elastic buffer circuit 107 and the descramble circuit 110. The elastic buffer circuit 107 receives a receiving signal from the receiving channel and adjusts a clock frequency of the sender. The descramble circuit 110 descrambles an output signal of the elastic buffer circuit 107. In this data receiving device, the receiving signal includes a COM symbol to initialize the descramble circuit 110 and a plurality of SKP symbols which are continuously arranged at the later part of the COM symbol as a data set in a data string. The data receiving device further includes a SKP/COM conversion circuit 109 between the elastic buffer circuit 107 and the descramble circuit 110. The SKP/COM conversion circuit 109 which converts data for adjusting timing in the data set into data for initializing.

FIG. 12 is a view for describing data which is input to the descramble circuit 110 of the data receiving device described in Tozaki. It is assumed that the data generated as shown in FIG. 12A includes an error, for example, in the first SKP symbol of the SKP ordered set as shown in FIG. 12B. In this case, according to the data receiving device of Tozaki, as shown in FIG. 12C, all the SKP symbols are replaced with COM symbols before descrambling. Therefore, even if SKP symbols include some errors, the initialization of the descramble circuit 110 is repeated for the number of times corresponding to the number of COM symbols after replacement. That is, the initialization is reliably performed, and therefore, the descramble processing of the receiver side reliably corresponds to the scramble processing of the sender side.

Recently, in a field of a data receiving device of high speed serial communication, speed-up and stability of data communication are both required. However, nowadays, USB3.0 also employs high speed serial transfer, and therefore, the possibility that data includes transmission noise is increased due to usage of communication cables in usage environment. Nowadays, there is an increasing demand for a communication device of high stability which does not require re-execution of transfer processing even when the symbol for adjusting timing is damaged by the transition noise with decreasing stabilities.

### SUMMARY

FIG. 13A to 13C each show is another example of data input to the descramble circuit 110 of Tozaki. It is assumed that the data generated as shown in FIG. 13A includes an error in the last SKP symbol of the SKP ordered setin a transmission path, for example, as shown in FIG. 13B. In the technique of Tozaki, as shown in FIG. 13C, in the case where the last SKP symbol of the SKP ordered set has been damaged, the descramble circuit 110 is not initialized. That is, the SKP symbols subsequent to the damaged SKP symbol are replaced with COM symbols. Thus, if the last SKP symbol of the SKP ordered set is damaged, it cannot be replaced with COM symbol. Therefore, the LFSRs are not initialized, and the descramble processing of the receiver side does not correspond to the scramble processing of the sender side. Hence, there is a problem that the transfer processing needs to be re-executed.

A first exemplary aspect of the present invention is a data receiving device including an elastic buffer which receives data as receiving data and adjusts timing with a sender, the data being scrambled and sent from the sender, an interpolation circuit which performs predetermined interpolation processing on the data subjected to timing adjustment by the elastic buffer to output the data, and a descramble circuit which descrambles the data output from the interpolation circuit. The receiving data includes data set for adjusting timing. The data set is for adjusting timing with the sender. The interpolation circuit replaces existing data with data for adjusting timing and outputs the data for adjusting timing as required after first receiving normal data for adjusting timing so that a desired number of data for adjusting timing is included in the data set for adjusting timing.

According to the present invention, the data receiving device includes an interpolation circuit at the previous stage of the descramble circuit. After receiving a normal data for adjusting timing, the interpolation circuit replaces existing data with data for adjusting timing to output required number of data for adjusting timing. This makes it possible to adjust timing of descramble processing even if a data set for adjusting timing includes an error.

A second exemplary aspect of the present invention is a data receiving method including receiving data that is scrambled and sent as receiving data, detecting data for adjusting timing included in a data set for adjusting timing, the data set is for adjusting timing with a sender, replacing existing data with the data for adjusting timing, outputting the data for adjusting timing as required after first receiving normal data for adjusting timing so that the a desired number of data for adjusting timing is included in the data set for adjusting timing, so as to adjust the timing with the sender, and descrambling and the data to output the descrambled data.

A third exemplary aspect of the present invention is a program product which executes the above-described data receiving processing.

According to the present invention, a data receiving device, a data receiving method and a program product which enable more stable high speed data transfer can be provided.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing a data sending device and a data receiving device according to an exemplary embodiment of the present invention;

FIG. 2 is a flow chart showing an operation of a SKP interpolation circuit according to the exemplary embodiment of the present invention;

FIG. 3A is a view showing a frame format of PCI Express bus method, especially, showing input data of a scramble circuit;

FIG. 3B is a view showing a frame format of PCI Express bus method, especially, showing output data from an 8 B/10 B decode circuit;

FIG. 3C is a view showing a frame format of PCI Express bus method, especially, showing output data from the SKP interpolation circuit;

FIG. 4 is a view showing data input to the scramble circuit in the case of USB 3.0 bus method;

FIG. 5 is a view showing input data to the scramble circuit and a descramble circuit of a sender side and a receiver side USB3.0 bus method;

FIG. 6A is a view showing an operation of the SKP interpolation circuit in the case where an error has occurred in a SKP ordered set in USB3.0 bus method, especially, showing input data of the scramble circuit;

FIG. 6B is a view showing an operation of the SKP interpolation circuit in the case where an error has occurred in a SKP ordered set of USB3.0 bus method, especially, showing an output data from the 8 B/10 B decode circuit;

FIG. 6C is a view showing an operation of the SKP interpolation circuit in the case where an error has occurred in a SKP ordered set in USB3.0 bus method, especially, showing an output data from a descramble circuit;

FIG. 7 is a view for describing an effect of the present invention in USB3.0 bus method;

FIG. 8 is a view showing a recovery operation in the case where the SKP interpolation circuit of the present invention is not employed;

FIG. 9 is a view showing a recovery operation in the data receiving device of the present invention;

FIG. 10 is a view showing a conventional data transfer device of PCI Express bus method;

FIG. 11 is a view showing a data receiving device of Tozaki;

FIG. 12A is a view showing data input to the data receiving device of Tozaki, especially, showing input data of a scramble circuit;

FIG. 12B is a view showing data input to the data receiving device of Tozaki, especially, showing output data from an 8 B/10 B decode circuit;

FIG. 12C is a view showing data input to the data receiving device of Tozaki, especially, showing output data from a descramble circuit;

FIG. 13A is a view showing another example of data input to the data receiving device of Tozaki, especially, showing input data of the scramble circuit;

FIG. 13B is a view showing another data example of input to the data receiving device of Tozaki, especially, showing output data from the 8 B/10 B decode circuit; and

FIG. 13C is a view showing another example of data input to the data receiving device of Tozaki, especially, showing output data from the descramble circuit.

### DETAILED DESCRIPTION OF THE EXEMPLARY EMBODIMENTS

Hereinafter, an exemplary embodiment of the present invention will be described in detail with reference to the drawings. This exemplary embodiment employs a data receiving device in a high speed serial communication such as PCI Express. As described above, when the final data (the final symbol) of the data set for adjusting timing has been damaged, the descramble processing of the receiver side does not correspond to the scramble processing of the sender side, and therefore the transmission processing would be re-executed. In contrast, in this exemplary embodiment of the present invention, after receiving a first normal data for adjusting timing, even if there is an error in subsequent data, all data will be replaced with the data for adjusting timing. That is, the receiving device always outputs the same number of data for adjusting timing as the data set for adjusting timing, thereby solving the above problem.

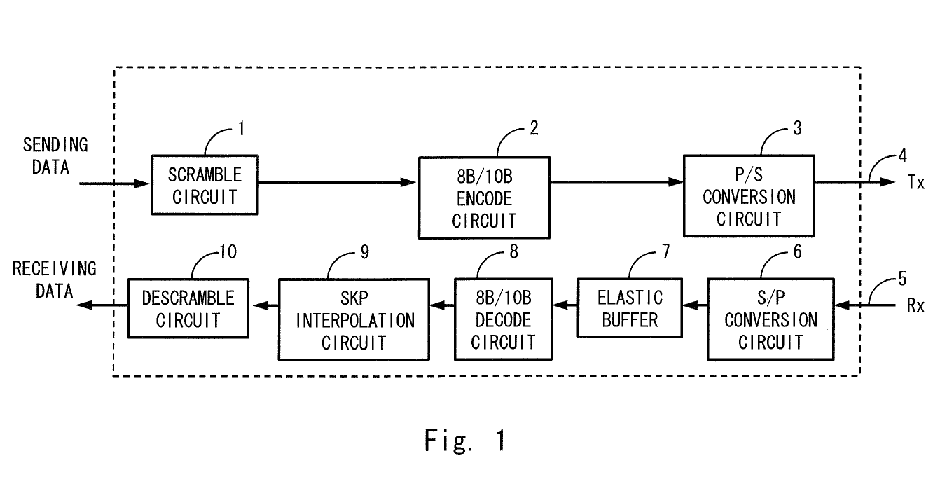

FIG. 1 is a view showing a data sending device and a data receiving device of the exemplary embodiment of the present invention. As shown in FIG. 1, the data receiving device includes a SKP interpolation circuit 9 instead of a SKP/COM conversion circuit disclosed in Tozaki. Other structures are the same as those of Tozaki.

That is, in the data sending device, sending data is scrambled in a scramble circuit 1. Next, the scrambled data is encoded from eight-bit data to ten-bit data by an 8 B/10 B encode circuit 2 so as not to continue “0” or “1” for a predetermined number of times. Then a P/S conversion circuit 3 converts parallel data into serial data, and outputs the serial data to a sending channel (lane) 4 of a differential type.

In the data receiving device, the data output from a receiving channel (lane) 5 of a differential type is converted from serial data into parallel data by an S/P conversion circuit 6. Next, an elastic buffer 7 adjusts a deviation of a clock frequency (gap) between the sender side and the receiver side, then an 8 B/10 B decode circuit 8 decodes from ten-bit data to eight-bit data, and the SKP interpolation circuit 9 performs predetermined interpolation processing on the data whose timing is adjusted by the elastic buffer 7. Then a descramble circuit 10 descrambles output data from the SKP interpolation circuit 9, and outputs it the descrambled data.

Here, the SKP interpolation circuit 9 outputs required number of SKP symbols instead of existing data after first receiving a normal SKP symbol so as to include the predetermined number of data for adjusting timing (hereinafter referred to as “SKP symbol”) included in the data set for adjusting timing (hereinafter referred to as “SKP ordered set”). For this purpose, the SKP interpolation circuit 9 includes a SKP counter (not shown) to count the required number of SKP symbols.

Then the SKP interpolation circuit 9 outputs required number of SKP symbols which form the SKP ordered set regardless of the kinds of symbols that are subsequently received after receiving a first normal SKP symbol. This achieves the effect that even if the last SKP symbol of the SKP ordered set is damaged, the scramble processing in the sender side does not conflict with the descramble processing in the receiver side and transfer processing is not re-executed.

Thus, the SKP interpolation circuit 9 recognizes the first SKP symbol. Then the SKP interpolation circuit 9 interpolates the SKP ordered set by replacing the received symbol with the SKP symbol regardless of the kind of the symbol and outputting the SKP symbol. The replacement process is performed on the SKP symbols that form the SKP ordered set, from the first SKP symbol that is recognized. Note that, the SKP interpolation circuit 9 outputs the required number of SKP symbols after first receiving a normal SKP symbol. At this time, whether the received symbol is the normal symbol or not, the SKP interpolation circuit 9 can replace all symbols with the SKP symbols and output these SKP symbols. Alternatively, the SKP interpolation circuit 9 can replace only the symbols other than the SKP symbols with the SKP symbols. In this case upon receiving a normal SKP symbol, the SKP interpolation circuit 9 does not replace it and outputs the normal SKP symbol without change.

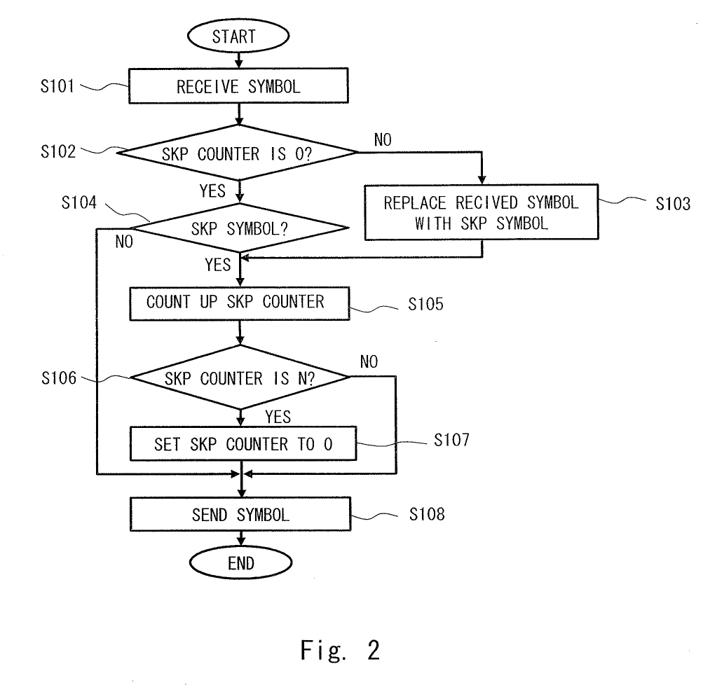

FIG. 2 is a flow chart showing the operation of the SKP interpolation circuit according to the exemplary embodiment of the present invention. As shown in FIG. 2, upon receiving a symbol (step S101), the SKP interpolation circuit 9 determines whether or not the SKP counter is zero (step S102). When the SKP counter is not zero, the SKP interpolation circuit 9 replaces the received symbol with the SKP symbol (step S103). On the other hand, when the SKP counter is zero, the SKP interpolation circuit 9 determines whether or not the received symbol is the SKP symbol (step S104). When the received symbol is the SKP symbol (step S104: Yes) or when the received symbol is replaced with the SKP symbol (step S103), the SKP counter is counted up (step S105).

Next, the SKP interpolation circuit 9 determines whether or not the SKP counter is N (step S106). Here, N indicates the number of SKP symbols included in the SKP ordered set. If the SKP counter is N, the SKP interpolation circuit 9 sets the SKP counter to zero (step S107). Then, the SKP interpolation circuit 9 sends the received symbol or the SKP symbol after replacement to the descramble circuit 10 (step S108). Note that, if the symbol is not the SKP symbol in step S104, and if the SKP counter is not N in step S106, the SKP interpolation circuit 9 also sends the symbol to the descramble circuit 10.

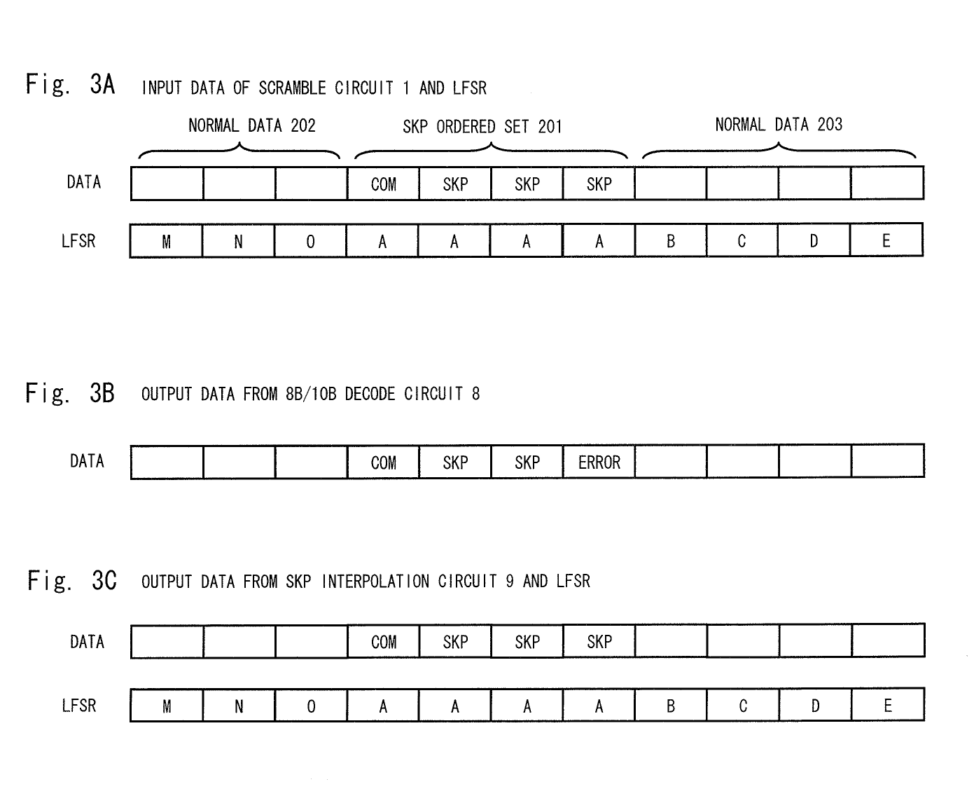

Next, an operation of PCI Express bus method will be explained in detail. FIGS. 3A to 3C each show a frame format of PCI Express bus method. FIG. 3A shows input data of the scramble circuit, FIG. 3B shows output data from an 8 B/10 B decode circuit, and FIG. 3C shows output data from the SKP interpolation circuit. As shown in FIG. 3A, a SKP ordered set 201 of PCI Express bus method includes one COM symbol and three SKP symbols in the sender side. The SKP ordered set 201 is arranged between normal data 202 and 203 which are symbols other than the COM symbol and the SKP symbol.

On the other hand, in the receiver side, the elastic buffer 7 changes the number of SKP symbols in the SKP ordered set and adjusts timing with the sender side. Therefore, the SKP ordered set 201 includes one COM symbol and five SKP symbols in the receiver side. Here, the number of SKP symbols included in the SKP ordered set is notified from the elastic buffer 7 to the SKP interpolation circuit 9. The SKP interpolation circuit 9 sets the number N of the SKP counters based on this notification.

Then, after detecting the first SKP symbol, the SKP interpolation circuit 9 replaces the symbols subsequent to the detected symbol into the SKP symbols, regardless of the type of the detected symbols. The number of SKP symbols output from the SKP interpolation circuit 9 may be set preliminarily. Alternatively, it may be determined from the data that the SKP interpolation circuit 9 receives, or may be set from outside. In the exemplary embodiment, it is assumed that the SKP interpolation circuit 9 is notified of the number from the elastic buffer 7.

Hereinafter, a case where the number of SKP symbols included in the SKP ordered set is three will be explained. For example, as shown in FIG. 3B, even though the third (the third SKP symbol in the SKP ordered set) is damaged and becomes an error symbol, after receiving the first SKP symbol, the SKP interpolation circuit 9 replaces the symbol received next with the SKP symbol, and outputs the SKP symbol to the descramble circuit 10. In this exemplary embodiment, the number of SKP symbols included in the SKP ordered set is three. Thus, after receiving the first SKP symbol, the SKP interpolation circuit 9 replaces two continuous received symbols with the SKP symbols to output the SKP symbols.

Therefore, as shown in FIG. 3C, the descramble circuit 10 receives three SKP symbols. By this, LFSR stops, and the scramble data corresponds to the descramble data after outputting three SKP symbols. At that time, even if the second SKP symbol is damaged, there is no effect.

Even if the second (the second SKP symbol of the SKP ordered set) is damaged and becomes an error symbol, the SKP interpolation circuit 9 outputs three SKP symbols. Therefore, in the descramble circuit 10, LFSR stops by receiving the three SKP symbols. Thus the scramble data corresponds to the descramble data after completing output of the three SKP symbols.

Furthermore, when the first (the first SKP symbol of the SKP ordered set) is damaged and becomes an error symbol, the error symbol is not replaced with the SKP symbol and is input to the descramble circuit 10. However, the SKP interpolation circuit 9 regards the second normal SKP symbol as the first SKP symbol, and outputs three SKP symbols including next two symbols in total. At the timing that the first SKP symbol should be input, the error symbol is input. Therefore, the LFSR of the descramble circuit 10 operates, However, as the three SKP symbols after the first symbol are input, the LFSR stops for the three symbols. Therefore the scramble data corresponds to the descramble data after completing output of the three SKP symbols.

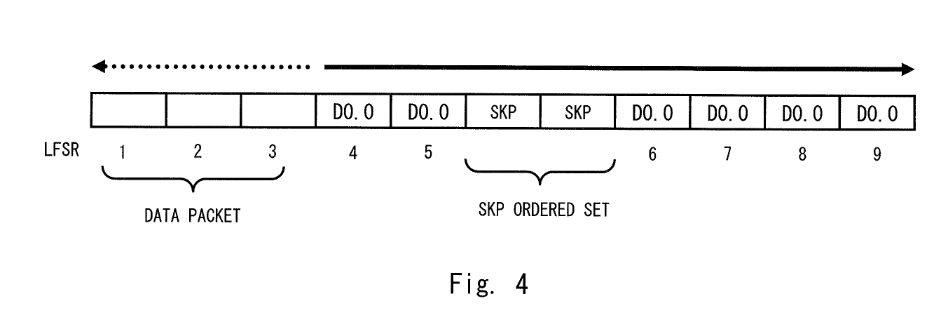

Next, an operation of USB3.0 bus method will be explained in detail. FIG. 4 is a view showing data input to the scramble circuit 1 in USB 3.0 bus method. As shown in FIG. 4, in USB3.0, the SKP ordered set is inserted at idle timing of data transfer (sending D0.0, that is sending D code 00h) with regular intervals (for every 354 symbols). During the sending of data packet (LFSR 1 to 3), the SKP ordered set is not inserted.

In USB3.0, the SKP ordered set consists of two SKP symbols. Unlike PCI Express, the SKP ordered set does not include the COM symbol. Therefore, the above N (the count value of the SKP counter) is usually set to two.

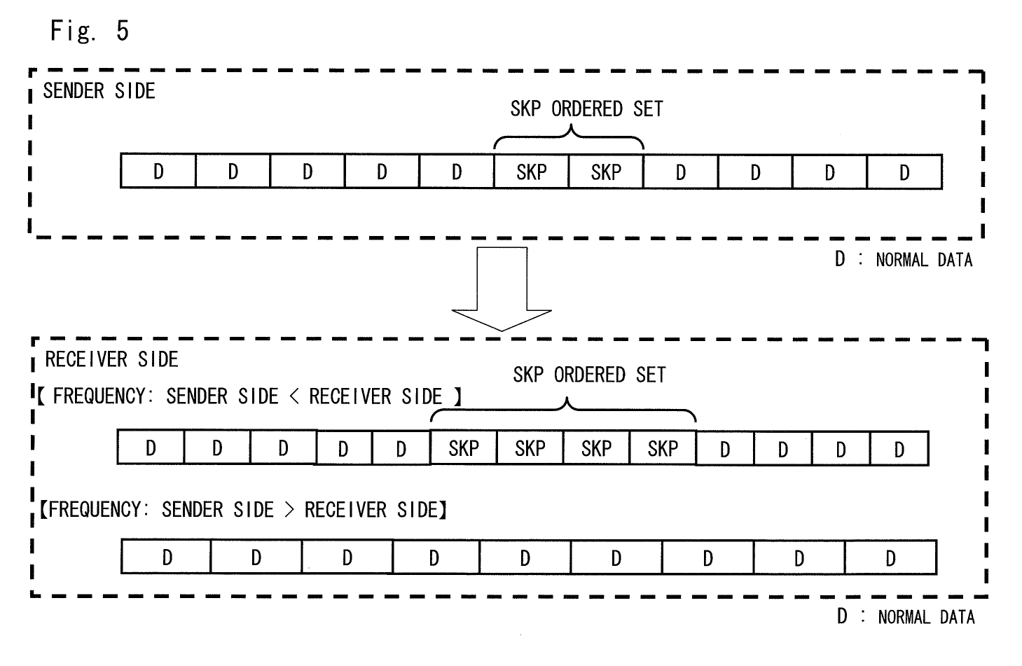

FIG. 5 is a view showing input data to the scramble circuit and the descramble circuit of a sender side and a receiver side in USB3.0 bus method. Since the elastic buffer 7 adjusts deviation of frequency (gap) in the unit of the SKP ordered set, the number of SKP symbols is changed. Since the number of SKP symbols is changed by two, therefore the number of N is always even number.

As shown in FIG. 5, for example, if the frequency of the sender side is small than that of the receiver side, a physical layer of the receiver side adds the SKP ordered set and sends it to a link layer. On the other hand, if the frequency of the sender side is larger than that of the receiver side, the physical layer of the receiver side deletes the SKP ordered set and sends it to a link layer. The LFSRs of the scramble circuit 1 and the descramble circuit 10 do not operate with the SKP symbols.

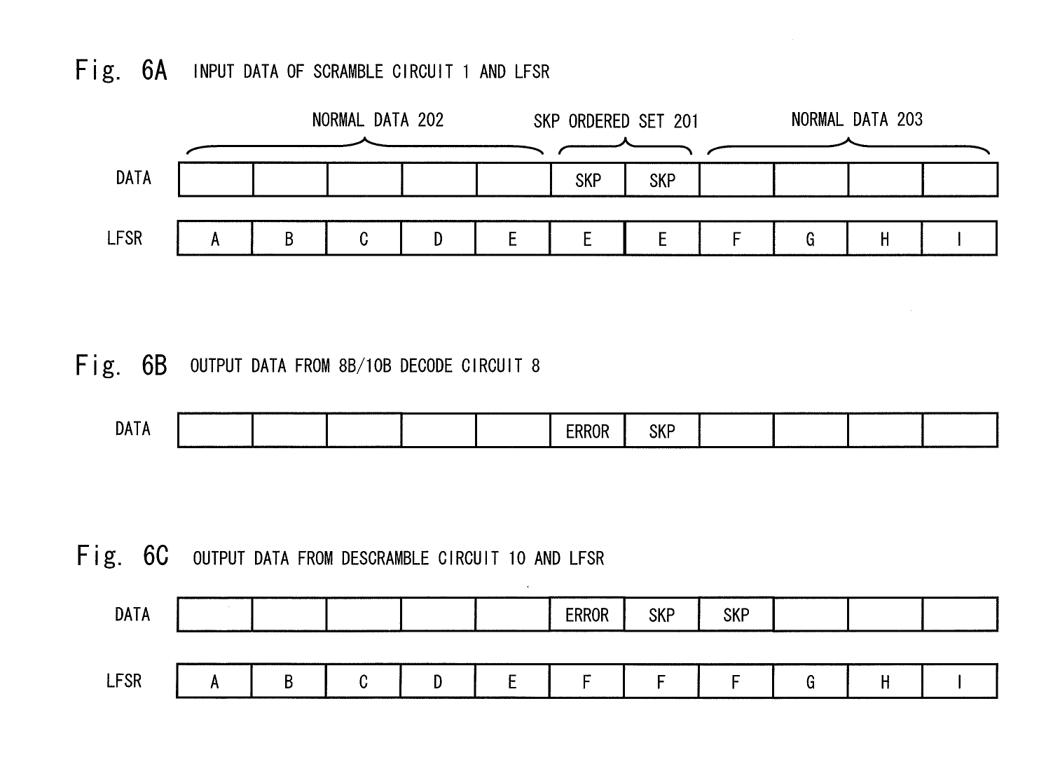

The SKP interpolation circuit 9, after recognizing the first SKP symbol, replaces the next symbol with the SKP symbol regardless of the type of the next symbol and outputs the SKP symbol. FIGS. 6A to 6C each show an operation of the SKP interpolation circuit in the case where an error has occurred in a SKP ordered set in USB3.0 bus method. FIG. 6A shows input data of the scramble circuit, FIG. 6B shows output data from the 8 B/10 B decode circuit, and FIG. 6C shows output data from the descramble circuit. As shown in FIG. 6A, the SKP ordered set 201 is inserted between normal data 202 and 203.

As shown in FIG. 6B, it is assumed that noise is superimposed on the first SKP symbol of the SKP ordered set 201 in the transmission channel and the first SKP symbol becomes an error symbol. In this case, the SKP interpolation circuit 9 outputs the error symbol without change to the descramble circuit 10. Then the second SKP symbol is regarded as the first symbol, and then the next symbol is replaced with the SKP symbol and the SKP symbol is output. At the timing at which the first SKP symbol should be input, the error symbol is input. Therefore the LFSR of the descramble circuit 10 operates. However, the LFSR stops by receiving two SKP symbols after the first SKP symbol. Thus, the scramble data can correspond to the descramble data after completing output of the two SKP symbols.

If the second SKP symbol is damaged and becomes an error symbol, the LFSR of the descramble circuit 10 stops be receiving the first normal SKP symbol and the next SKP symbol after replacement. Therefore, the scramble data can correspond to the descramble data after completing output of the two SKP symbols.

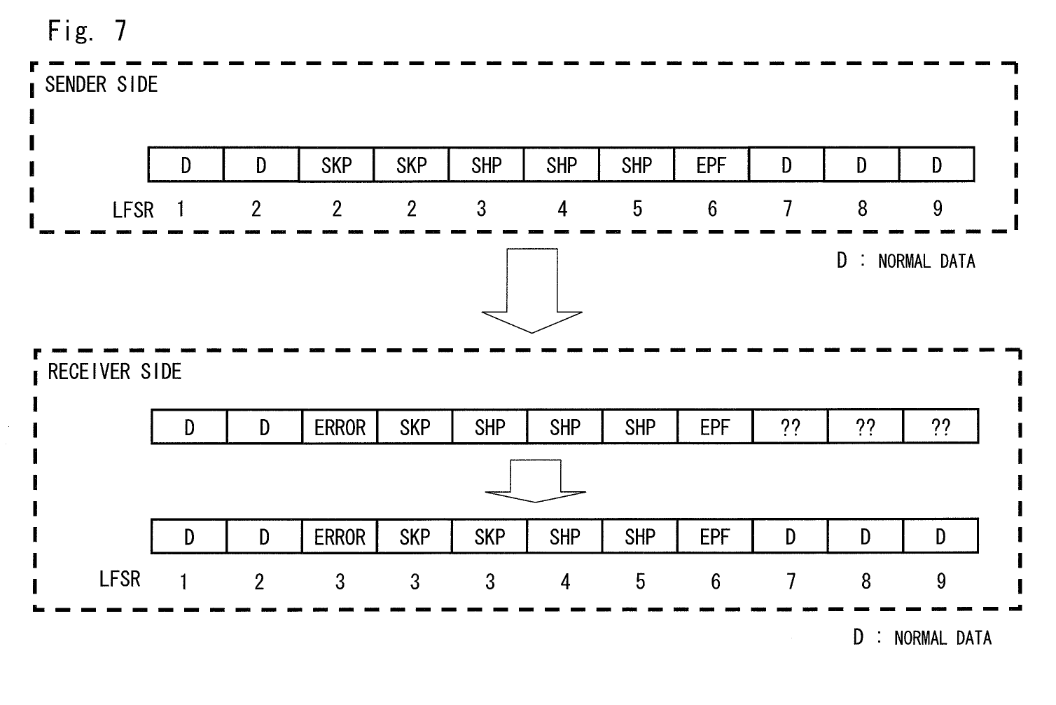

Next, data transfer of USB3.0 method will be explained in detail. FIG. 7 is a view for describing an effect of the present invention in USB3.0 bus method. As shown in FIG. 7, the sender side sends data into which two SKP symbols are inserted as the SKP ordered set. In this case, assume that the first SKP symbol of the SKP ordered set becomes an error symbol. The SKP interpolation circuit 9, after receiving the second normal SKP symbol, outputs two continuous SKP symbols. The LFSR of the descramble circuit 10 shifts by the error symbol, but the LFSR stops for two symbols by two SKP symbols after the error symbol. Thus, subsequent data including the fourth data of LFSR become normal data. Incidentally, in USB3.0, four symbols (SHP, SHP, SHP, EPF) are defined as a data set indicating a start of the data packet. If three of them (SHP, SHP, EPF) can be read out, the start of the data packet are recognized. Therefore, in this example, three of four symbols are descrambled normally, and the start of the data packet can be recognized.

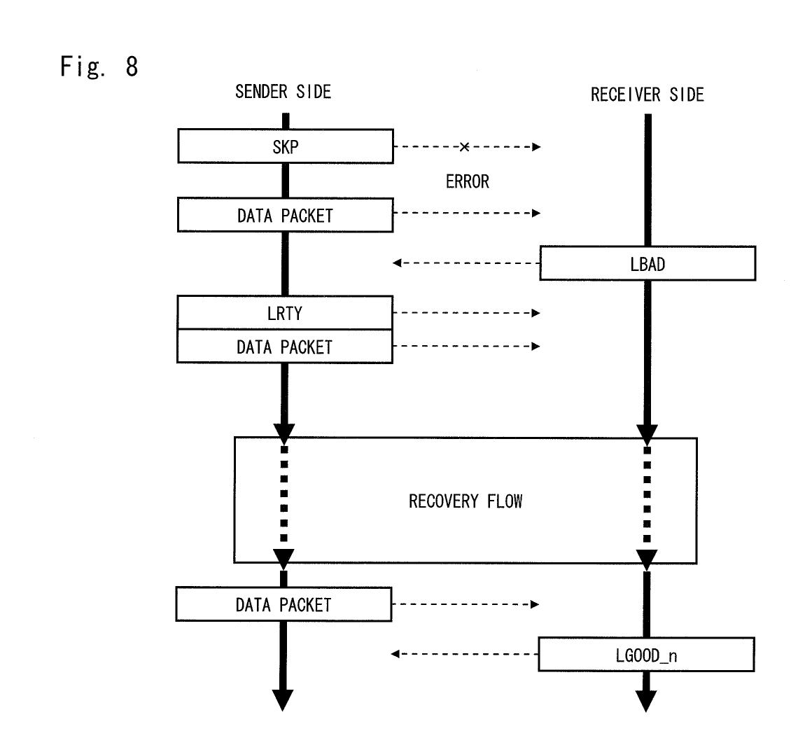

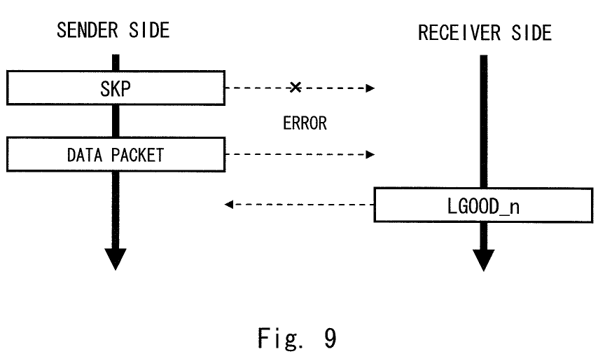

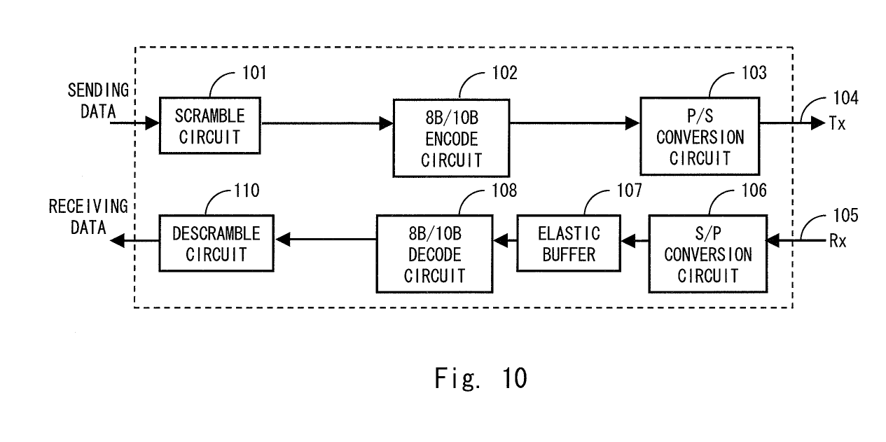

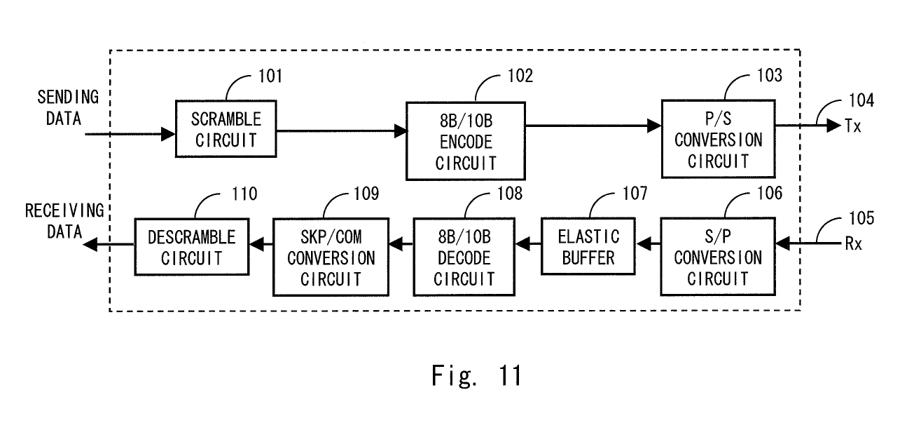

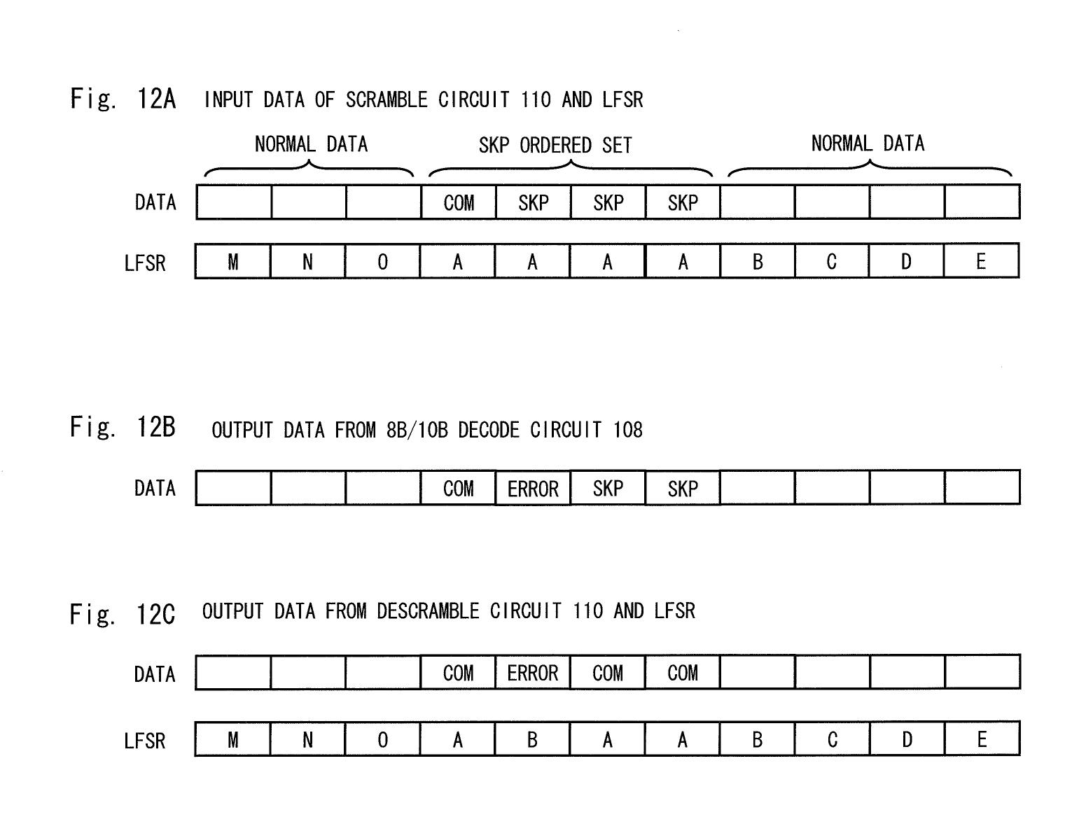

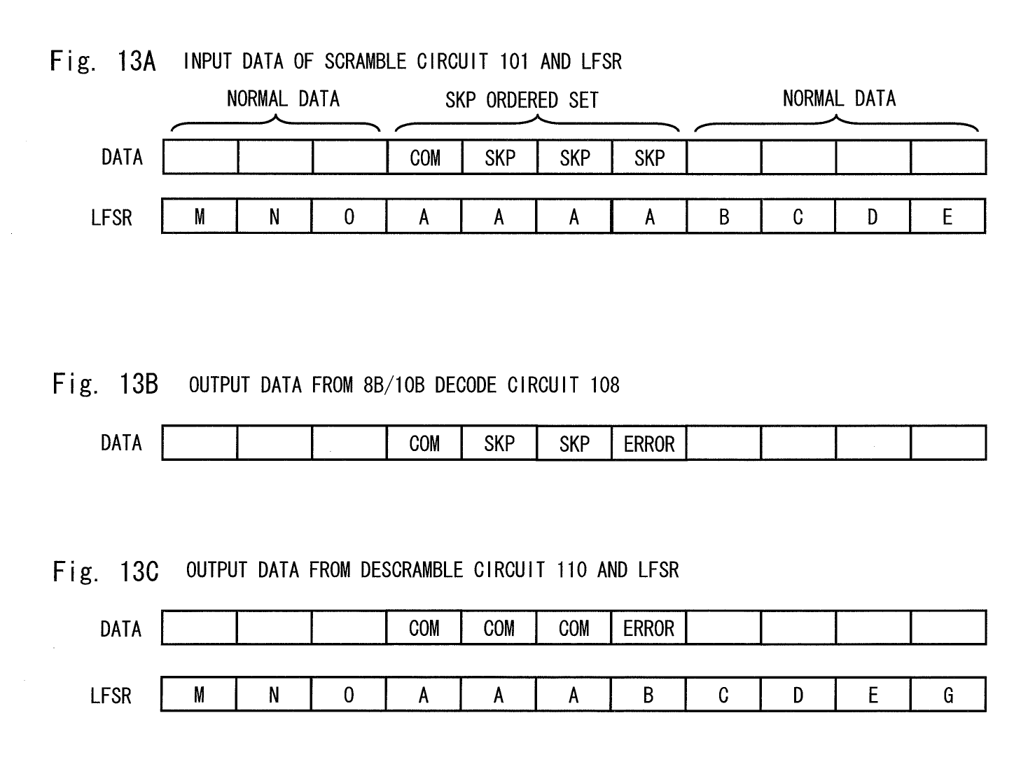

FIG. 8 is a view showing a recovery operation in the case where the SKP interpolation circuit of the present invention is not employed, and FIG. 9 is a view showing a recovery operation in the data receiving device of the present invention.

As shown in FIG. 8, if an error occurs in a SKP symbol, data packet sent from the sender side is not received normally. In this case, notification (LBAD) is sent from the receiver side indicating that data cannot be received. The sender side sends a notification of retrying (LRTY) and data packet. At this time, if data receiving completion signal is not sent from the receiver side to the sender side for a predetermined period, the sender side determines that a time out has occurred, and starts recovery processing. In the recovery processing, the sender side sends COM symbol and so on so as to initialize the descramble circuit. In the receiver side, the timing of the descramble processing is adjusted by this COM symbol. Then, the receiver side is able to receive data from the sender side normally. If the receiver side can receive data normally, the receiver side sends a notification indicating completion of data reception (LGOOD_n) to the sender side. In this way, in the prior technique, if an error occurs in the data set for adjusting timing, the recovery flow is started. Therefore there is a problem that data transfer speed is decreased.

On the other hand, as described above, in the present exemplary embodiment, even if an error occurs in the SKP ordered set, the device outputs required number of SKP symbols instead of the subsequent data after receiving the first SKP symbol so that the predetermined number of SKP symbols are included in the SKP ordered set. As shown in FIG. 9, even if an error occurs in the SKP ordered set, data packet subsequent to the error symbol can be received. That is, the recovery flow does not start, and the decreasing of data transfer rate is restrained.

In the present exemplary embodiment, even if there is an error in a SKP symbol which forms the SKP ordered set, the SKP interpolation circuit 9 successively outputs two SKP symbols in series after receiving a normal SKP symbol. Thus three SKP symbols are output in total. Therefore, it is possible to match the timing of the descramble and scramble processing.

Therefore, in USB3.0 method, even if there is an error in any SKP symbol which forms the SKP ordered set, the descramble processing is performed normally. On the other hand, in the technique of Tozaki, if there is an error in the SKP ordered set in USB3.0 method, the recovery flow is always needed. Thus it is difficult to increase the transfer rate.

The present invention provides the following advantageous effects. The first effect is that, even if the last SKP symbol of the SKP ordered set is damaged, transfer processing need not be re-executed. The reason is as follows. The receiving device always outputs the predetermined number of SKP symbols which constitute the SKP ordered set. That is, regardless of the kind of the next symbol, the receiving device outputs the required number of SKP symbols which constitute the SKP ordered set are output after receiving a first normal SKP symbol. Accordingly, the SKP ordered set can be interpolated, and there is no conflict between the LFSRs of the scramble circuit and the descramble circuit.

The second effect is that the present invention can be applied to the communication standard such as USB3.0, where the symbol which initializes the LFSRs of the scramble and descramble circuits is not defined in the SKP ordered set. The reason is that the COM symbol which initializes the LFSR of the descramble circuit is not used.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

For example, in the above exemplary embodiment, the data receiving device is explained as hardware. However, an arbitrary processing can be achieved by executing a program by CPU (Central Processing Unit). The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, PCI Express and USB3.0 have different numbers of SKP symbols in the timing ordered set. Therefore, the SKP interpolation circuit 9 may include a function to determine the standard of the current data. To set the numbers of SKP symbols N (set value of the SKP counter) based on the determination result. Alternatively, the value N of the SKP counter may be set by an external instruction. Since the count value of the SKP counter of the SKP interpolation circuit 9 can be variably set changeable, even if any standard, the above interpolation process can be performed regardless of the standards of data.

What is claimed is:

1. A data receiving device comprising:
an elastic buffer which receives data as receiving data and adjusts timing with a sender, the data being scrambled and sent from the sender;
an interpolation circuit which performs predetermined interpolation processing on the data subjected to timing adjustment by the elastic buffer to output the data; and
a descramble circuit which descrambles the data output from the interpolation circuit,
wherein the receiving data includes data set for adjusting timing, the data set is for adjusting timing with the sender,
wherein the interpolation circuit replaces existing data with data for adjusting timing and outputs the data for adjusting timing as required after first receiving normal data for adjusting timing so that a desired number of data for adjusting timing is included in the data set for adjusting timing.

2. The data receiving device according to claim 1, wherein the data set for adjusting timing is a SKP ordered set, and the data for adjusting timing is a SKP symbol.

3. The data receiving device according to claim 1, wherein the number of the data for adjusting timing output from the interpolation circuit is set to an arbitrary number.

4. The data receiving device according to claim 1, wherein the elastic buffer adjusts timing by a unit of the data set for adjusting timing.

5. The data receiving device according to claim 1, wherein the elastic buffer adjusts timing by changing amount of the data for adjusting timing included in the data set for adjusting timing.

6. The data receiving device according to claim 1, wherein the interpolation circuit counts the number of the data for adjusting timing included in the data set for adjusting timing based on a notification from the elastic buffer, and replaces existing data with data for adjusting timing according to the number of the data for adjusting timing after first receiving the data for adjusting timing.

7. The data receiving device according to claim 1, wherein the receiving data is received using USB3.0 bus.

8. The data receiving device according to claim 1, wherein the receiving data is received using PCI Express bus.

9. A data receiving method comprising:
receiving data that is scrambled and sent as receiving data;
detecting data for adjusting timing included in a data set for adjusting timing, the data set is for adjusting timing with a sender;
replacing existing data with the data for adjusting timing, outputting the data for adjusting timing as required after first receiving normal data for adjusting timing so that the desired number of data for adjusting timing is included in the data set for adjusting timing, so as to adjust the timing with the sender; and
descrambling the data to output the descrambled data.

10. The data receiving method according to claim 9, wherein the data set for adjusting timing is a SKP ordered set, and the data for adjusting timing is a SKP symbol.

11. The data receiving method according to claim 9, wherein the number of existing data which is replaced with the data for adjusting timing to output the data for adjusting timing after first receiving normal data for adjusting timing is set to an arbitrary number.

12. The data receiving method according to claim 9, wherein timing of the receiving data is adjusted by a unit of the data set for adjusting timing.

13. The data receiving method according to claim 9, wherein timing of the receiving data is adjusted by changing amount of the data for adjusting timing included in the data set for adjusting timing.

14. The data receiving method according to claim 9, comprising:
counting the number of the data for adjusting timing included in the data set for adjusting timing based on a notification from an elastic buffer, the elastic buffer adjusting timing of receiving data with a sender; and
replacing existing data with data for adjusting timing to output the data for adjusting timing according to the number of the data for adjusting timing after first receiving the data for adjusting timing.

15. The data receiving method according to claim 9, wherein the receiving data is received using USB3.0 bus.

16. The data receiving method according to claim 9, wherein the receiving data is received using PCI Express bus.

17. A computer program product comprising:
receiving data that is scrambled and sent as receiving data;
detecting data for adjusting timing included in a data set for adjusting timing to the data set is for adjusting timing with a sender;
replacing existing data with the data for adjusting timing, outputting the data for adjusting timing as required after first receiving normal data for adjusting timing so that the a desired number of data for adjusting timing is included in the data set for adjusting timing, so as to adjust the timing with the sender; and
descrambling the data to output the descrambled data.
